(19) United States
(12) Patent Application Publication
(10) Pub. No.: US 2016/0128406 A1
(43) Pub. Date: May 12, 2016

(54) FARBRIC FOR WATER SPORTS GARMENT

(71) Applicant: Shei Chung Hsin Ind. Co., Ltd., Yilan County (TW)

(72) Inventor: Min-Chen SHIUE, Yilan County (TW)

(21) Appl. No.: 14/537,875

(22) Filed: Nov. 10, 2014

(51) Int. Cl. A41D 31/02; B32B 5/18; B32B 5/24; B32B 5/02

(52) U.S. Cl. CPC A41D 31/02; B32B 5/024; B32B 5/18; B32B 5/245; B32B 2250/03; B32B 2262/0261; B32B 2266/0207; B32B 2262/0207; B32B 2307/73; B32B 2437/00

(57) ABSTRACT

A fabric for water sports garment includes a foam rubber layer, a first layer and a second layer. The foam rubber layer has a first surface and a second surface opposite to the first surface. The first layer is laminated on the first surface of the foam rubber layer, and the first layer has a plurality of types of multifilament yarns, and each of the multifilament yarns is 5-20 denier. The second layer is laminated on the second surface of the foam rubber layer.

### BACKGROUND

1. Field of Invention

The present invention relates to a woven fabric. More particularly, the present invention relates to a woven fabric for water sports garment.

2. Description of Related Art

Water sports clothing should exhibit several characteristics, for example, fast drying, thermal insulation, wear resistance and flexibility. Taking wetsuit for instance. Wetsuit is commonly used in many water sports both on the water and under water including surfing, scuba diving, white-water rafting and kayaking. Wetsuit acts as a protection layer on a wearer, preventing or minimizing undesired contact. Because of the nature of water sports, which involves a number of cycles in and out of the water or extended contact with water, a piece of suitable clothing has to drain excessive water in a short time frame.

Conventional fabric for water sports includes three layers, an outer layer, an inner layer and an foam rubber layer. The outer layer is laminated on one side of the foam rubber layer, and the inner layer is also attached to the foam rubber layer while opposite to the outer layer. The composite fabric is heavy due to yarns having higher denier such as 45 or even higher. In addition to the weight, the fabric has a considerable thickness. Most importantly, water is more likely to be trapped in the high denier fabric because the fabric is constructed by yarns containing more filaments (e.g. 48 filaments for a 45-denier yarn) that create voids for accommodating foreign particles. As a result, the rate of drainage is low, and it will take much longer time for drying. More specifically, a conventional wetsuit may weigh up to at least 2 kg when it is dry, and it can retain approximately 1.4 kg water after soaking. It is a great burden (i.e. 3.4 kg) to the wearer on top of other water sports equipment. Therefore, there is a need for a thin in profile, lightweight and fast drying fabric that can remedy the abovementioned issues.

### SUMMARY

The invention provides a fabric for water sports garment. The fabric includes a foam rubber layer, a first layer and a second layer. The foam rubber layer has a first surface and a second surface opposite to the first surface. The first layer is laminated on the first surface of the foam rubber layer, and the first layer has a plurality of types of multifilament yarns, and each of the multifilament yarns is 5-20 denier. The second layer is laminated on the second surface of the foam rubber layer. Each of the multifilament yarns has a filament count of 8 filaments. More specifically, the second layer is constructed by a plurality of multifilament yarns, and each of the yarns is 5-20 denier. The first layers has a thickness ranging from 0.1 to 0.3 mm. The multifilament yarns of the first layer has a smaller denier number than that of the second layer. In addition, the fabric is water repellent.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiment, with reference made to the accompanying drawings as follows.

FIG. 1 is a schematic view of a fabric in accordance with an embodiment of the instant disclosure;

FIG. 2A is a microscopic cross-sectional view showing a conventional outer layer constructed by yarns having 45 denier (48 filaments);

FIG. 2B is a microscopic cross-sectional view showing a fabric in accordance with an embodiment of the instant disclosure;

FIG. 3A is a microscopic top view showing a conventional outer layer constructed by yarns having 45 denier (48 filaments); and

FIG. 3B is a microscopic top view showing a fabric in accordance with an embodiment of the instant disclosure.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

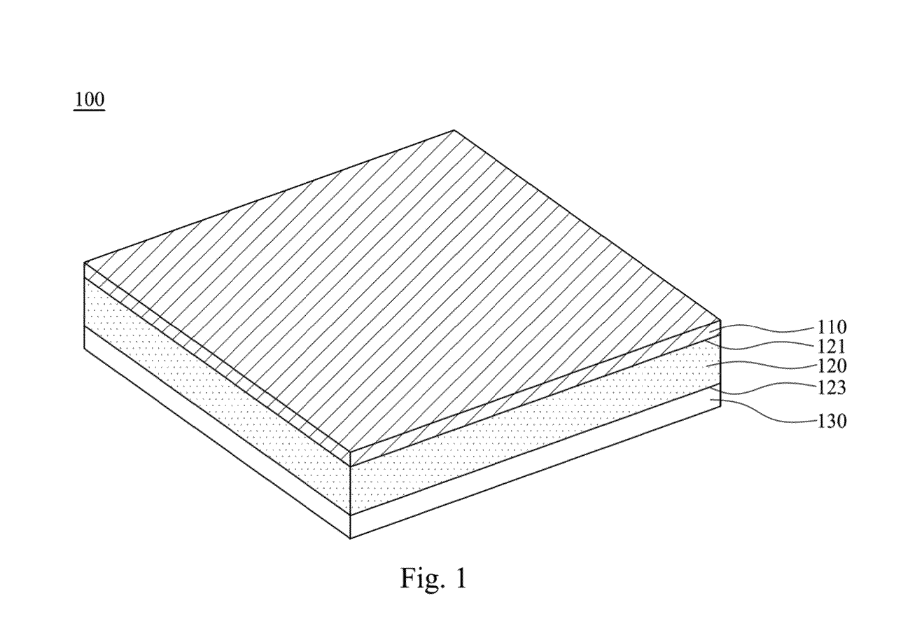

Please refer to FIG. 1 that shows a schematic view of a fabric 100 in accordance with an embodiment of the instant disclosure. The fabric 100 includes a first layer 110, a foam rubber layer 120 and a second layer 130. The foam rubber layer has a first surface 121 and a second surface 123 opposite to the first surface 121. The first layer 110 is laminated on the first surface 121, while the second layer 130 is laminated on the second surface 123 opposed to the first layer 110. The raw material of the first and second layers 110, 130 is preferably nylon (polyamide). Nylon tends to be semi-crystalline and considered a type of tough material because of its stiffness, low friction coefficient and chemical resistance. The desirable mechanical and thermal properties (i.e. low heat conductivity) offered by nylon allow its wide implementation to fiber, especially in the domain of water activity fabric. A variety of chemicals can be used to reinforce nylon system. For example, by adding heat stabilizer, nylon shows stronger durability under high temperature environment. Alternatively, carbon black can be added to nylon so as to reduce UV light degradation. Nylon may undergo further poly processing for a specific purpose and be applied to the instant disclosure. Furthermore, other polymers such as polyester, polyurethane, polypropylene and the combination thereof may also be used.

The first layer 110 is constructed by a plurality of multifilament yarns. The multifilament yarns include two different types of yarns, which are a core yarn and an elastic yarn. According to Table 1, a comparative sample contains a first layer, and its core yarn is 45 denier, and its elastic yarn is 20 denier. The multifilament core yarn of the first layer 110 is 15 denier, and the elastic multifilament yarn is 15 denier. Hereinafter the multifilament core yarn is described as core yarn for the sake of clarity, and the same applies to the elastic multifilament yarn as the elastic yarn. Although the core yarns of the comparative example and the instant disclosure are both multifilament yarns, the disparity arises from the filament count. Namely, the 45-denier core yarn of the comparative example consists of 48 filaments, whereas the 15-denier core yarn is constructed by 8 filaments. The difference in filament count contributes to a great reduction in the first layer 110 dry weight. In comparison with the first layer of the comparative example, the first layer 110 weighs 52 g/m² which is almost ⅓ of the comparative example. On the other hand, the second layer 130 of the fabric 100 is knitted by 20-denier yarn. The 20-denier yarn is half in weight compared to the comparative second layer that is constructed by 40-denier yarn. The first and second layers 110, 130 can be knitted by a circular knitting machine that has a needle count ranging from 32-60 gauge/inch. It should be understood that the denier number of the yarns in both the first and second layers 110, 130 ranges from 5 to 20 denier, and the instant embodiment is a preferable example. It should be noted that the filament count results in not only the lightweight but also the drainage rate that be elaborated further.

TABLE 1
Fabric Comparison

| | Comparative Example | Exemplary Embodiment |
|---|---|---|
| First Layer | | |
| Core Yarn (denier) | 45 | 15 |
| Elastic Yarn (denier) | 20 | 15 |
| Dry Weight (g/m²) | 138 | 52 |
| Second Layer | | |
| Yarn (Denier) | 40 | 20 |
| Dry Weight (g/m²) | 98 | 45 |

The first layer 110 is attached to the first surface 121 of the foam rubber layer 120 while the second layer 120 to the second surface 123 through common adhesive process known to one of ordinary skill in the art to form the fabric 100. The foam rubber layer 120 in the embodiment has a thickness of 3 mm and serves to increase the thermal insulation, heat retention and water repellency. Examples of suitable materials for the foam rubber layer 120 include foamed polymer materials (e.g. polyurethane, ethyvinylacetate), various types of rubbers and polymer sheets. The thickness of the foam rubber layer 120 can also be reduced to 1 mm according to different requirement. When combining the first and second layers 110, 130 with the foam rubber layer 120, the weight difference in comparison with the conventional fabric is less significant. In another embodiment, a different type of foam rubber layer, namely, lighter or thinner, may be used to further reduce the weight of fabric 100.

The performance of water absorption and drainage of fabric 100 is shown in Table 2. The fabric dry weight refers to the combined weight of first layer, second layer plus the foam rubber layer for both the comparative example and the fabric 100. Both samples were measured with 120 cm against 220 cm which resembles a common wetsuit dimension. The dry fabrics were weighed before they were dipped into the water. As shown in Table 2, the comparative example weighed 1875 g, and the fabric 100 weighed 1618 g. Subsequently, the fabrics were soaked in the water for a given time to mimic under water activity like scuba diving that a user will immerse torso, limbs and even head completely below the water surface. Once the fabrics were retrieved from under the water, the water retention ability was immediately measured. The comparative example retained almost 1.4 kg water on the fabric. In contrast, the fabric 100 only attracted 0.7 kg water. A significant difference of water retention shown at the first stage. More specifically, to begin with, the difference of overall dry weight between the comparative example and fabric 100 was less than 15%. However, after immersion, water trapped in the fabric 100 was 50% less than that in the comparative example. In other words, under the same given time the fabric 100 drew considerably less water. Although identical major material (i.e. nylon) was used for all the components and the initial dry weights were not far from each other, the rate of water absorption of fabric 100 was half of the comparative example. It can be seen that the decrease of filament count and further to the denier number contributes to low water retention ability in the case of fabric 100.

TABLE 2
Fabric Water Absorption and Drainage

| | Comparative Example | Exemplary Embodiment |
|---|---|---|
| Fabric Dry Weight* (g/sheet**) | 1875 | 1618 |
| Water Retention*** (g/sheet) | 1359 | 713 |
| Water Retention After 1 Hour (g/sheet) | 917 | 313 |

*Fabric dry weight: first layer, second layer and foam rubber layer
** sheet: 120 cm × 220 cm (close to a common wetsuit dimension)
***Water retention: weight of water alone was recorded without the fabric

After the fabrics were retrieved and left dry for 1 hour, water was measured again in both fabrics. The remaining water in the conventional fabric was 917 g, and in the fabric 100 it was merely 313 g. The ability of water drainage was shown. The comparative example and the fabric 100 both lost about 400 g of water. However, it should be noted that the comparative example started with a greater water weight which was 1359 g, while the fabric 100 had only 713 g of water at the beginning. More specifically, the fabric 100 shed 56% of its water in an hour, and the comparative example lost just 32% under the same condition. According to the above experiment, it can be seen that the fabric 100 exhibits the characteristics of low water absorption and high drainage rate.

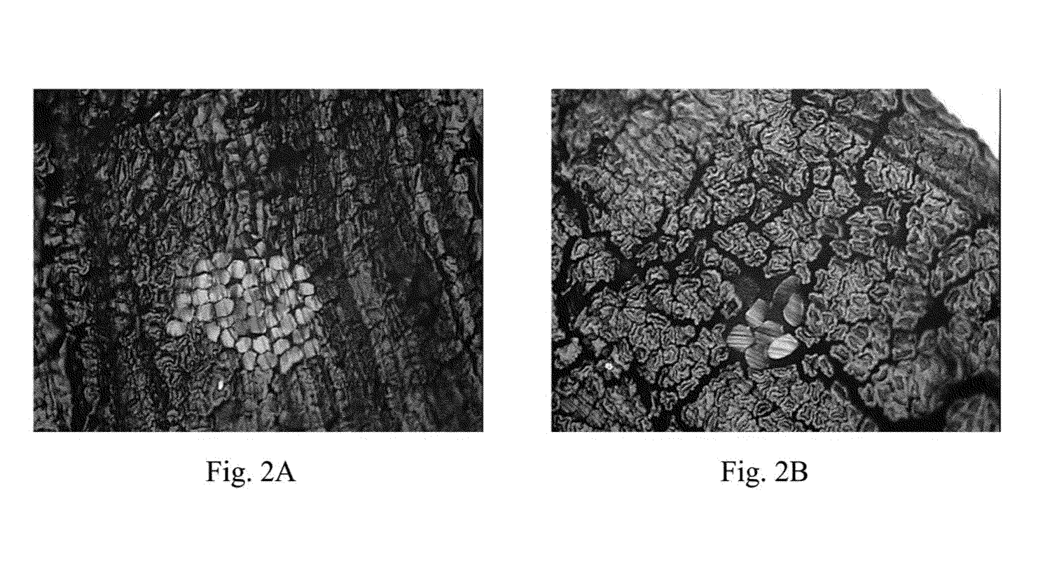

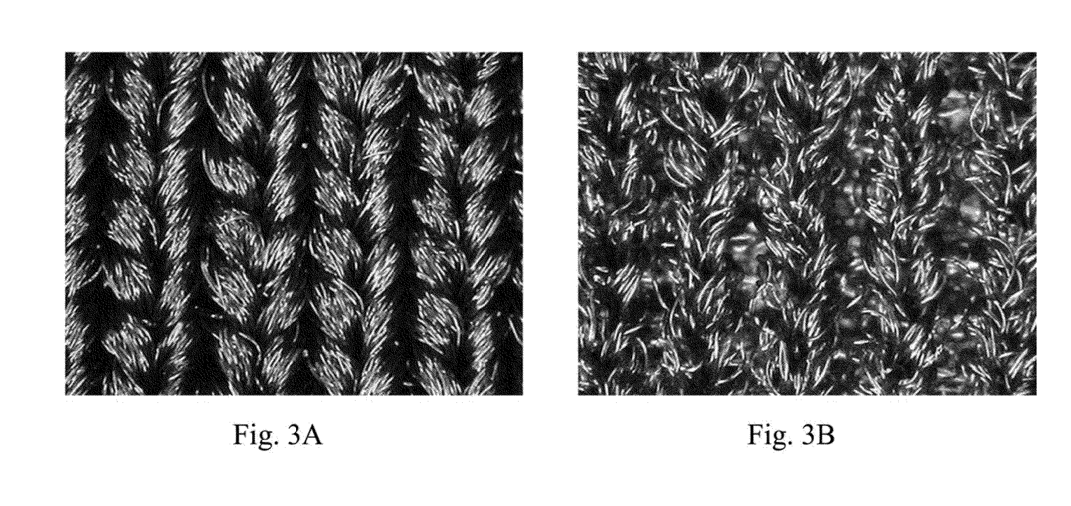

From the above experiment, it is clear that the fabric 100 absorbs less liquid compared to the comparative example, and the fabric 100 dries faster as well. The main reason is elaborated hereafter. Please refer to FIG. 2A. The comparative example is constructed by 45-denier core yarn, which has 48 filaments, and 20-denier elastic yarn. The intertwined 48 filaments of the 45-denier core yarn create a plurality of voids and pockets at the intersection when they are bundled to construct a single core yarn. As a result, the 45-denier core yarn is formed with pores and corners that can accommodate liquid. Once the liquid is trapped in these places, the comparative example chiefly relies on evaporation to dry. It should be emphasized that under most circumstances, the evaporation rate is heavily determined by ambient humidity. In contrast, the first layer 110 is constructed by 15-denier core yarn, which has 8 filaments, and 15-denier elastic yarn. The filament count of the 15-denier core yarn is much less than that of the 45-denier core yarn such that when constructing the 15-denier, i.e. 8 filaments, core yarn, the pore/pocket ratio is significantly reduced in a single core yarn as shown in FIG. 2B. As the pore/pocket ratio reduces, liquid is less likely to be drawn and remained on the fabric such that the fabric 100 retains much less water after immersion under the water. Please refer to FIG. 3A which shows a microscopic top view of the comparative example. Because the 45-denier core yarn has a larger cross section (FIG. 2A), it results in a dense topology and higher surface area compared to the first layer 110. Attention is now drawn to FIG. 2B in conjunction with FIG. 3B which shows a microscopic top view of the first layer 110. It can be seen that because the 15-denier core yarn has a smaller cross-sectional view (FIG. 2B), when knitting the first layer 110, the first layer 110 has a lower surface area in a given region (FIG. 3B). When it comes to overall surface area, a high surface area implies higher liquid absorption since the amide bond of nylon exhibit a degree of hydrophilic property although the hydrophilicity may vary according to the kind of polyamide. That explains another reason why the fabric 100 drew less water after it was dipped into the water.

In addition to the abovementioned advantages of the fabric 100, the first and second layers 110, 130 have a thinner profile in comparison with the comparative example. The first and second layer 110, 130 have an average thickness ranging from 0.1 to 0.3 mm. The thinness arises from the smaller filament counts where the first layer 110 uses 15-denier multifilament yarns and the second layer 130 uses 20-denier multifilament yarns. The low filament counts result in smaller cross section, and the overall profile of the first and second layers 110, 130 reduces altogether. The reduced layer profile facilitates evaporation of the fabric 100 since the liquid locked in the foam rubber layer 120 can be released faster with greater exposure and shorter distance to travel through. When the fabric 100 is used in a wetsuit, the second layer 130 is proximate to a wearer's skin, while the first layer 110 is directed toward the ambient environment. In other words, the first layer 110 is the outer layer in relation to the second layer 130. The drainage rate benefits from this arrangement because the thinner first layer 110 allows an even faster water evaporation speed than the second layer 130. More specifically, when drying the fabric 100, water quickly evaporates or is drained from the first layer 110. Subsequently, water from the foam rubber layer 120 and in succession the second layer 130 can be released to the ambience with a faster speed in the scarcity of water retained in the first layer 110. The strength of the thinner first layer 110 can be enhanced by specialized sewing methods. For instance, a strip of neoprene can be used at the position of seam to transfer the required strength at sawing. The strip can be applied before sawing, or alternatively, after sawing. The strip of neoprene can be replaced by a hot melt adhesive tape or a liquid tape.

In the event of splashing, water drops remain integral on the fabric 110 since the few filaments of the first layer 110 hardly absorb the water. Water drops can slide down from the first layer 110, leaving the fabric 100 almost intact. However, when a small amount of water is poured on the comparative example, a portion of the water drops is absorbed immediately with visible water stain thereon. The fabric 100 shows its water repellent property in this experiment.

In view of the above, the fabric for water sports garment exhibits the properties of low water absorption and fast drying. The first layer of the fabric includes different types of multifilament yarns ranging from 5 to 20 denier. In addition to low denier, each of the yarns is constructed by a relatively small number of filaments (e.g., 8 filaments). The low filament count contributes significantly to low water absorption and fast drying. Firstly, fewer filament count results in less voids or pockets in one strand of the multifilament yarn such that liquid is less likely to be trapped. Furthermore, the cross section of the multifilament yarn reduces because of the small number of filaments. When knitting the first layer, the layer profile is thinner and accounts for less surface area. That is to say, the low voids/pocket ratio draws minimum liquid within each filament, and there are fewer filaments to absorb moisture from the ambience. In general, the fabric attracts much less moisture in comparison with conventional fabric for water spots. In addition, the thin profile of the first layer facilitates moisture evaporation from the foam rubber layer or the second layer. Any liquid that is absorbed by the first layer can easily evaporate since the first layer is thin such that a distance to the ambient environment is shorter. Also, each yarn is spatially separated so as to minimize cohesion between liquid molecules. As the moisture evaporates from the first or the second layer, the liquid locked in the foam rubber layer can be released in a faster rate. The quick drainage rate of the fabric arises from these properties.

The fabric can be implemented in a wide range of aquatic garment including full suit, spring suit, long john, jacket or vest. Accordingly, various types of wetsuit can incorporate the fabric of the instant disclosure.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A fabric for water sports garment, comprising:
a foam rubber layer having a first surface and a second surface opposite to the first surface;
a first layer laminated on the first surface of the foam rubber layer, the first layer having a plurality of types of multifilament yarns, each of the multifilament yarns being 5-20 denier; and
a second layer laminated on the second surface of the foam rubber layer.

2. The fabric for water sports garment of claim 1, wherein each of the multifilament yarns has a filament count of 8 filaments.

3. The fabric for water sports garment of claim 2, wherein one type of the multifilament yarns is an elastic multifilament yarn.

4. The fabric for water sports garment of claim 1, wherein the first layer has a thickness ranging from 0.1 to 0.3 mm.

5. The fabric for water sports garment of claim 1, wherein the second layer has a thickness ranging from 0.1 to 0.3 mm.

6. The fabric for water sports garment of claim 1, wherein the second layer is constructed by a plurality of multifilament yarns, and each of the yarns ranges from 5 to 20 denier.

7. The fabric for water sports garment of claim 6, wherein the plurality of types of multifilament yarns of the first layer has a smaller denier than the multifilament yarns of the second layer.

8. The fabric for water sports garment of claim 1, wherein the first and second layers are independently made of nylon.

9. The fabric for water sports garment of claim 1, wherein the fabric is water repellent.
